(19) United States
(12) Patent Application Publication
(10) Pub. No.: US 2024/0359803 A1
(43) Pub. Date: Oct. 31, 2024

(54) MULTI-MATERIAL JOINT

(71) Applicant: AIRBUS OPERATIONS LIMITED, Bristol (GB)

(72) Inventor: Martin MUIR, Bristol (GB)

(21) Appl. No.: 18/292,114

(22) PCT Filed: Jul. 19, 2022
(86) PCT No.: PCT/EP2022/070241

§ 371 Date: Jan. 25, 2024

(30) Foreign Application Priority Data
Jul. 27, 2021 (GB) 2110753.7

(51) Int. Cl. B64D 27/40; B22F 10/28; B23K 26/342; B33Y 10/00; B33Y 80/00; B64D 27/18

(52) U.S. Cl. CPC B64D 27/402; B22F 10/28; B23K 26/342; B33Y 10/00; B33Y 80/00; B22F 2998/10; B64D 27/18

(57) ABSTRACT

A multi-material component is provided including two members formed of different materials joined together at a multi-material join. The two members have complementary protrusions that form a multi-material join with a zig-zag interface, such that a tension between them is experienced in at least part as a shear force at the interface between the protrusions. The component further includes a third member connected to the first member by a lattice, which is capable of elastic deformation so as to substantially isolate the interface between the complementary protrusions from deformation of the third member such as that caused by thermal expansion. Methods of designing and constructing such a component in a single piece via additive manufacturing are provided. The component is particularly suitable for use in pylons connecting jet engines to aircraft wings.

### TECHNICAL FIELD

The present invention relates to components formed of two different materials; ways of designing the same; and ways of constructing multi-material components. Such components are particularly suitable for use in aircraft.

### BACKGROUND

When designing components to that must handle a significant thermal input load, methods for controlling the effects of that thermal load must be considered and implemented. An example of such an application is illustrated in FIG. 1. An aircraft 1 has engines 2 which generate significant amounts of heat. These engines 2 are connected to the aircraft (typically the wings 3) by means of a pylon 4.

The thermal load coming from the engine is typically managed by the use of thermally stable materials such as Inconel. Problematically, whilst Inconel provides a good thermal solution in specific zones, it does not present an optimal economic or performance benefit when used to excess. As such, considerable time and effort is placed into the design of structures and systems made from multiple materials, in order to provide for a high performance, thermally safe structure/system. Unfortunately, whilst the resultant structures are lighter and cheaper than a monolithic material suitable for the thermal load, they are not truly optimal due to their need for both a high part count bill of materials and significant assembly costs for the different components made from different materials.

One potential solution to the high part count and high assembly costs is to use multi-material additive manufacturing to create monolithic components comprising multiple materials. However such multi-material components face two significant challenges. Firstly, dissimilar materials may have differing thermal expansion rates. In the context of significant thermal loads, this presents a serious challenge to overcome. Secondly, dissimilar materials may not bond well to each other. In the case of Inconel and Aluminium, for example, brittle inter-metallic compounds can form at the interface between the materials which may impair the strength of the component.

Accordingly it is desirable to provide a multi-material component that can be created via additive manufacturing but mitigates the challenges of thermal expansion and/or impaired bonding.

### SUMMARY

A first aspect of the present invention provides a multi-material component comprising: a first member formed of a first material and a second member formed of a second material, the first and second members each comprising complementary interlocking protrusions that form a multi-material join and define an interface between the first and second members such that a substantial proportion of any tension between the first and second members across the multi-material join is experienced as a shear force at the convoluted interface; a third member; and a lattice member situated and joined between the first member and the third member, the lattice being capable of elastic deformation so as to substantially isolate the multi-material join from any deformation of the third member.

Preferably, the third member and lattice member are formed of the first material.

Preferably, the lattice has an elastic limit below the breaking stress of the multi-material join so as to allow non-destructive inspection of the component by inspecting the lattice for plastic deformation.

Optionally, the first material and second material have substantially different coefficients of thermal expansion.

Optionally, the first material and second materials are metals that form brittle inter-metallic compounds when welded together.

Preferably, at least one of the first member and second member have been formed by additive manufacture upon the other member such that the interface between the complementary protrusions has been formed by additive manufacture.

Optionally, the first member comprises holes for receiving the protrusions of the second member.

Optionally, the complementary protrusions are elongated so as to form a series of complementary ridges.

Optionally, the complementary protrusions are barbed.

Preferably, the complementary protrusions are spaced across the multi-material join such that no significant part of the interface is parallel to the plane of the multi-material join.

A second aspect of the present invention provides a method of designing a multi-material component for use in coupling a heat source to a vehicle, the multi-material component comprising a first member formed of a first material and a second member formed of a second material, the first and second members each comprising complementary interlocking protrusions that form a multi-material join and define a convoluted interface between the first and second members; and a lattice member situated and joined between the first member and a third member; the method comprising: selecting the first material and second material; identifying an operating temperature for the third member; identifying a maximum acceptable temperature of the second material; determining a range of acceptable values for thermal conductivity of the lattice which will, at the operating temperature of the third member, prevent the temperature of the second member exceeding the maximum acceptable temperature; and using software to generate the design of the lattice with a thermal conductivity within the range of acceptable values.

Preferably, the second material is Aluminium and the maximum acceptable temperature is 300 degrees Celsius.

A further aspect of the present invention provides a pylon for connecting a heat source to an aircraft structure, the pylon comprising the multi-material component, wherein: the third member is coupled to the heat source; and the second member is coupled to the aircraft structure.

A third aspect of the invention provides a method of creating a multi-material component, the component comprising a multi-material join where two different materials are joined together, the method comprising: a first step of providing a second member formed of a second material, the second member comprising a plurality of protrusions; a second step of constructing via additive manufacturing a first member formed of the first material on the second member by first constructing a plurality of protrusions complementary to those of the second member so as to create an interface between the complementary protrusions of the second and first member; a third step of constructing via additive manufacturing a lattice formed of the first material on the first member; a fourth step of constructing via additive manufacturing the third member formed of the first material on the lattice; wherein the lattice is configured to elastically deform so as to substantially isolate the interface between the complementary protrusions from distortions in a third member connected to the lattice.

Preferably, the step of providing the second member comprises constructing the second member via additive manufacturing.

Preferably, the complementary protrusions on the second and first member are constructed at the same time via multi-material additive manufacturing.

A fourth aspect of the present invention provides a method of creating a multi-material component, the component comprising a multi-material join where two different material are joined together, the method comprising: a first step of providing a third member formed of a first material; a second step of constructing via additive manufacturing a lattice formed of the first material on the first member, the lattice being configured to elastically deform so as to substantially isolate the side of the lattice distal from the third member from distortions in the third member; a third step of constructing via additive manufacturing a first member formed of the first material on the lattice, the first member comprising a plurality of protrusions; and a fourth step of constructing via additive manufacturing a second member formed of a second material, the second member comprising a plurality of protrusions complementary to those of the first member so as to create an interface between the complementary protrusions of the first and second member.

### BRIEF DESCRIPTION OF THE DRAWINGS

Embodiments of the invention will now be described, by way of example only, with reference to the accompanying drawings, in which:

FIG. 1 is an aircraft; and

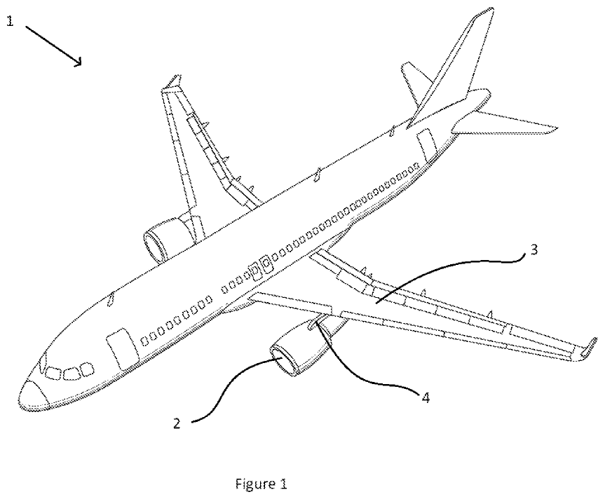

FIG. 2 is a schematic cross section view of a multi-material component;

FIG. 3 is a schematic perspective view of an embodiment of the first member;

FIGS. 4a-d are schematic cross section views of stages of construction of a multi-material component according to an embodiment;

FIGS. 5a-d are schematic cross section views of stages of construction of a multi-material component according to a second embodiment; and

FIGS. 6a-c are schematic cross section views of alternative multi-material components.

### DETAILED DESCRIPTION

As previously described, pylons for use on aircraft to support an engine (or other heat source) on part of the aircraft structure must be robust to the heat generated by the engine and to the loads exerted on them. Although a monolithic component formed of a high-performance material such as Inconel may be suitable, the density and cost of such materials is typically much higher than other aircraft materials such as Aluminium or Titanium and therefore it is desirable to minimise the use of materials like Inconel where possible. Such materials may be joined together with less dense or expensive materials by use of fasteners or similar, but this results in a component that comprises several parts increasing the bill of materials and potentially introducing features such as drilled holes which may need ongoing inspection.

Accordingly, it is desirable to provide a multi-material monolithic component, which minimises the use of denser or more expensive materials without requiring the added complexity of fasteners or similar. Such a multi-material component is particularly suitable for use in a pylon 4 for connecting an aircraft engine 2 to an aircraft wing 3.

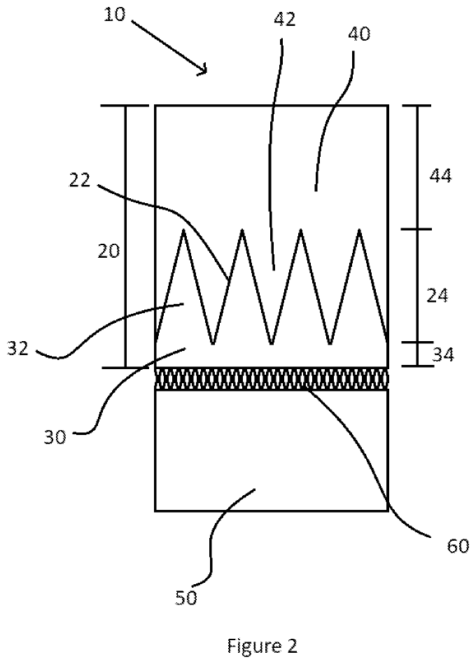

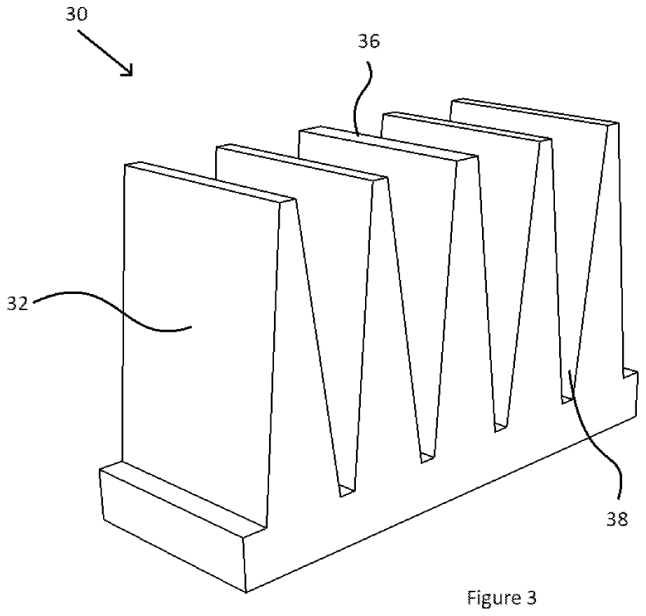

With reference to FIG. 2, a multi-material component 10 is shown according to an embodiment of this disclosure. The multi-material component 10 comprises a multi-material member 20 which itself comprises a first member 30 formed of a first material and a second member 40 formed of a second material. The first material is preferably more thermally stable or heat resistant than the second material. The first and second member are joined together at a multi-material join 24. Although the join 24 is on the whole planar, the actual interface 22 between the first member 30 and second member 40 is not. As shown in FIG. 3, the first member 30 has a first set of protrusions 32 in the form of a series of generally triangular ridges each having a peak 36 and defining a recess 38 between each adjacent set of peaks. The second member 40 has a second set of protrusions 42 which are complementary to the first protrusions 32. The peak of the protrusions of one member are arranged to be located and engage in the recess of the other member and interlock with each other to form the interface 22. The interface 22 so formed is convoluted, having in cross-section a zigzag profile as shown in FIG. 3.

These protrusions are spaced across the multi-material join 24 such that no significant part of the interface 24 between the two members 30, 40 is parallel to the join 24. As shown in FIG. 3, the protrusions 32, 42 may take the form of ridges that interlock completely, leaving no empty space between the first member 30 and second member 40. The protrusions 32, 42 preferably have a high aspect ratio such that their sides are oriented at more than 45 degrees from the plane of the multi-material join 24, and more preferably are close to perpendicular to the plane of multi-material join 24. At the base and peak 36 of each of the protrusions 32, 42 there may be a flat area that is parallel to the join 24. As previously mentioned it is preferable that the flat area is small.

A benefit of these protrusions 32, 42 is that any tension across the multi-material component 10 (that is orthogonal to the plane of the join 24) is experienced in substantial part as shear force at the interface 22 between the protrusions 32, 42. It has been found that the interface between dissimilar materials is often stronger with respect to shear force rather than tension. This is the case, for example, for the interface between Aluminium and Inconel where brittle inter-metallic compounds form between the two materials. Such compounds, although fragile to tension forces, are markedly stronger to shear forces.

A further benefit of the protrusions 32, 42 is to increase the total surface area of the interface 22. This may improve the overall strength of the join 24 by spreading out any load over a wider surface area.

The multi-material component 10 further comprises a third member, 50. The third member forms the part of the multi-material component 10 suited for connecting to the heat source, and is formed of the same material as the first member 20 and is situated adjacent to the first member 20 on the other side of the first member 20 to the join 24. The third member is connected to the first member by means of a lattice 60. The lattice 60 is also formed of the same material as the first member 20 and third member 50. The lattice 60 is capable of a degree of elastic deformation.

The lattice 60 preferably comprises a series of struts connecting face of the first member 20 to the face of the third member 50. The struts may be perpendicular to the faces of the first member 20 and third member 50, or more preferably the lattice may comprise a series of struts at different angles so as to provide a variety of load paths through the lattice. The lattice 60 may be irregular, regular or have one or more unit cells which are tessellated across the space of the lattice 60.

The lattice 60 may cover the face of the first member 20 and third member 50 without interruptions, or alternatively one or more voids in the lattice between the struts may extend all the way to the face of the first member 20 and/or the third member 50.

In use as a component in an aircraft pylon, the third member 50, being formed of the more thermally stable first material, is able to handle the high heat that can be produced by the engine and can therefore be coupled to it. Heat from the engine may cause thermal expansion in third member 50. The lattice 60 acts to isolate the multi-material join 24 (and more specifically the interface 22) between the first member 30 and second member 40 from the deformation of the third member 50. The isolation is achieved primarily by elastic deformation of the lattice in response to the deformation of the third member 50.

The multi-material member 20 (and in particular the second member 40) can be coupled to the aircraft wing 3. The component 10 thereby is available as a unitary body or monolithic component, simplifying assembly of the pylon 4. When compared to multi-part structures, the parts count and assembly requirements are reduced. The isolation of the interface 22 from deformation in the third member 50 mitigates problems with the interface of the two materials. The size of the first and third member can be selected so as to minimise the use of the first material and maximise the use of the second material, potentially reducing the weight or cost of the component 10.

One source of deformation of the third member 50 is thermal expansion in response to thermal load from the aircraft engine, which may reach very high temperatures. This may be particularly problematic when the first material and second material have substantially different coefficients of thermal expansion. Since it is the third member 50 which is connected to the engine it will be the first to thermally deform in response to the thermal load. The lattice 60 will elastically deform in response to this thermal deformation of the third member 50 which will reduce any stress encountered by the multi-material member 20.

Apart from elastic deformation, the lattice 60 also serves to isolate the interface 22 thermally. Since lattices comprise a significant amount of open space their thermal conductivity is lower than the bulk material. Accordingly the lattice 60 may serve to prevent any transient thermal loads significantly affecting the temperature of the multi-material member 20, mitigating such issues. Furthermore by reducing the rate of conduction to the multi-material member 20 any temperature change in the multi-material member 20 may be further mitigated by thermal transfer with the surrounding environment.

The thermal insulation provided by the lattice 60 may be further improved if it is permeable to a surrounding fluid, particularly air at a temperature lower than the thermal load. The high surface area of the lattice 60 may serve to conduct heat into the fluid, thereby further mitigating the thermal load transmitted through the lattice 60.

Preferably, the second member 40 has a significantly greater mass or size than the first member 30. In this embodiment the body 34 of the first member 30 (that part of the member 30 that is not part of the protrusions 32) is very thin when compared to the body 44 of the second member. The material serves primarily as an anchor point for the lattice 60 and does not need to make up a substantial part of the multi-material member 20.

The multi-material component 10 may be obtained via additive manufacture, such as powder bed laser sintering or direct energy deposition. This could be a multi-step process of first depositing one material before depositing the other. Alternatively, there are additive manufacture techniques that allow multiple materials to be deposited at the same time, allowing the component 10 to be constructed in a single step.

In either case the use of additive manufacture provides a strong bond between the first member 30 and second member 40 since each part of the interface 22 is well bonded together during the additive manufacture process. This may also enable the use of particularly high aspect ratio protrusions 32, 42 since the protrusions will not be liable to be bent or damaged during bringing the first member 30 and second member 40 together for bonding. The multi-material component can be created from the top down (starting with the second member 40) or from the bottom up (starting with the third member 50).

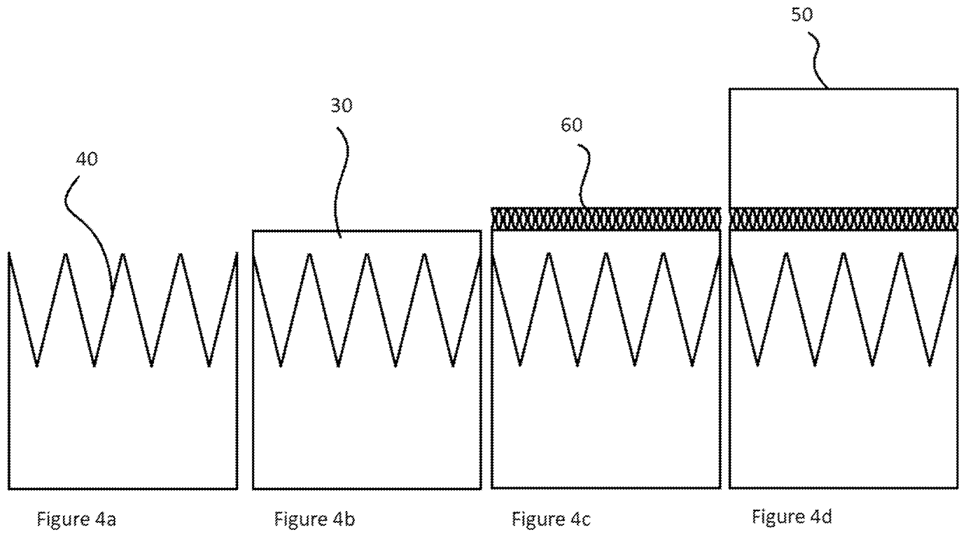

The steps of forming the component 10 from the top down is shown in FIGS. 4a-d. The first part of this method of creating the multi-material component 10 is providing the second member 40 as shown in FIG. 4a. This may be done by simply machining a block of the second material to provide a second member 40 with protrusions 42. Alternatively, a block of the second material may form (at least part of) the body 44 of the second member, with the protrusions 42 (and possibly some other parts of the body 44) being manufactured in place on the body 44 by additive manufacture. Further alternatively, the entirety of the second member 40 may be constructed by additive manufacture.

Next as shown in FIG. 4b, the first member 30 is manufactured upon the second member 40, with the protrusions 32 of the first member 30 filling the gaps in the protrusions 42 of the second member 40. If the component 10 is being manufactured via multi-material additive manufacture, then the protrusions 32, 42 may be printed sequentially or simultaneously. The first member 30 is formed of the first material which is different to the second material from which the second member 40 is formed. Accordingly during this step the interface 22 between the two materials is formed.

Once the first member 30 is formed then the lattice 60 can be formed upon it as shown in FIG. 4c. The lattice may be formed via a similar or different additive manufacturing technology to that used for the other parts of the component 10. For example, binder jetting or droplet printing may be particularly suitable for forming the lattice 60.

Finally, the third member 50 can be formed upon the lattice 60 as shown in FIG. 4d. Both the third member 50 and lattice 60 are formed of the first material so these steps can be performed sequentially if third member 50 is formed via additive manufacturing.

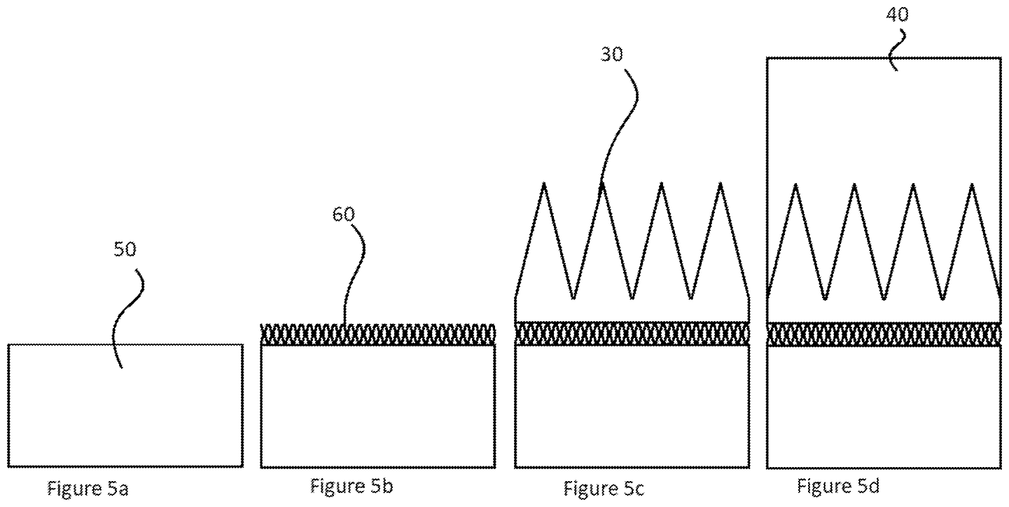

The steps of forming the component 10 from the bottom up is shown in FIGS. 5a-d. The first part of the method of creating the multi-material component is providing the third member 50 as shown in FIG. 5a. Again, this may be done by simply providing a block of the first material; manufacturing the third member in place by additive manufacture; or a combination of the two. The lattice 60 and then the first member 30 can then be printed upon the third member 50 as shown in FIGS. 5b and 5c.

The second member 40 (being formed of the second material, different to the others) can then be printed upon the first member 30 as shown in FIG. 5d as described above, with its protrusions 42 filling the gaps in the protrusions 32 of the first member 30. This may printed after the first member 30 has been formed, or simultaneously using multi-material additive manufacture.

The skilled person will realise that a key feature of the multi-material component 10 is the lattice 60, which is selected so as to provide elastic deformation under commonly-encountered loads and optionally a degree of thermal insulation. The loads the lattice 60 is exposed to are not just those of thermal deformation but also whatever loads are to be transmitted through the component 10, which in the case of a component 10 to be used in a pylon 4 for mounting an engine 2 to an aircraft wing 3 can be significant.

There are a number of existing available methodologies for creating lattice designs, such as the software products Materialise®, OptiStruct® and nTopology®. Any suitable lattice can be used that is capable of withstanding the loading that will be put on the multi-material component 10. However, it is particularly advantageous to tune the elastic limit of the lattice 60. If the elastic limit of the lattice 60 is set to below the breaking stress of the multi-material join 24 then a new avenue for non-destructive testing becomes available. The lattice 60 can be inspected to see if plastic deformation has occurred. This may be done by visual inspection of the lattice 60, or simply measuring if the height of the lattice 60 or the overall component 10. If no plastic deformation has occurred, then it can be determined that the multi-material component 10 has not been exposed to sufficient stress to jeopardise the multi-material join 24. In contrast, if plastic deformation has been detected, the part can be identified for replacement or further inspection. Accordingly an initial judgement of the integrity of the part can be carried out without more involved non-destructive testing methods such as the use of X-rays.

It is possible to determine a value for the breaking stress of the multi-material join 24 by directly measuring it, or alternatively by calibrating a simulation using material values derived from testing of similar joins. When devising the lattice it can be configured with an appropriate elastic limit by setting the modulus as having an allowable value of the lower bound for the breaking stress of the multi material join 24 (or an appropriate offset) before then solving the lattice to minimise reserve in the lattice (maximise stress) subject to a known input load, constraints and material conditions.

An approximation to the thermal conductivity of the lattice 60 can be calculated simply by comparing the density of the lattice 60 with that of the solid material and applying that ratio to the thermal conductivity of the material. Accordingly, if the maximum operating temperature of the third member 50 is known and the ambient temperature around the second member 40 is known it is possible to design the lattice 60 to have a thermal conductivity suitable for limiting the maximum temperature experienced by the second member 40 in either the steady state situation or if the thermal load is limited to a known period of time.

It is desirable to be able to control the maximum temperature experienced by the second member 40 since it is made from the second material, which may be less thermally stable than the first material. In the particular case of Aluminium being the second material, it is particularly desirable to ensure that the second member does not reach a temperature exceeding 300 degrees Celsius since above that temperature Aluminium may start to oxidise and lose some of its structural strength. Accordingly in such cases it is desirable to design the lattice to have a thermal conductivity low enough, taking into account the other effects, such that at any operating temperature for the third member the temperature of the second member does not exceed 300 degrees Celsius.

A further consideration for controlling the temperature of the second member 40 is the possibility of the lattice 60 being permeable to a fluid that can be served to mitigate the thermal load. In use the fluid could be directed to circulate through the lattice 60 by active means or passively harnessing flows in the fluid, such as wind or airflow in the case that the fluid is air. In the case of use on an aircraft ambient air moving over the aircraft may be a good source of such fluid and be so harnessed.

As described above the lattice 60 can be designed so as to provide for one means of simple non-destructive testing of the component 10 and to ensure that the temperature of the second member 40 (and the aircraft wing 3) is not exposed to high temperatures. The skilled person will realise that the multi material component 10 is suitable for use in other pylons where any heat source is to be connected by the component 10 to a structure. For example, the multi-material component 10 could be used to connect heat sources such as generators, fuel cells or electric motors to the wings or other parts of the aircraft such as the fuselage or empennage.

As previously mentioned the multi-material component 10 is particularly suitable for construction from the first material being Inconel and the second material being Aluminium. Such a combination does form the brittle inter-metallic compounds described above. However, many other combinations of materials are envisioned, particularly the second material being Titanium with the first material being Inconel. The approach described herein can also be used with non-metals including plastics, particularly those that do not adhere well to each other, such as Polypropylene and ABS.

Furthermore, although the first member 20, lattice 60 and third member 50 are all described as being formed of the same first material, in some cases one or more of these may be formed of a different material or even a combination of different materials that do not suffer from adverse bonding. For example, materials may be selected which bond well to each other without the formation of brittle areas and without having significantly different coefficients of thermal expansion. For example, it may be desirable to use a different Inconel alloy in the lattice 60 than in the first member 20 or third member 50 that has a higher strength (to counteract the higher loading put on the lattice members vis-à-vis the bulk material) or a higher modulus of elasticity (to allow for more elastic deformation in the lattice).

Further alternative applications for the multi-material component 10 could be to cases where the thermal load is extremely cold, causing contraction of the third member 50 rather than expansion. Alternatively, the multi-material component could be used to isolate the interface 22 between the dissimilar materials from deformation in the third member 50 caused by vibration or forces acting on that member.

The skilled person will realise that some deviation from the component 10 described above and as shown in the figures may be desirable in some cases. For example, the join 24 need not be planar, but may be curved or even contain discontinuities depending on the characteristics of what the component 10 is to connect to.

Furthermore, the protrusions 32, 42 may take a variety of different forms, such as spikes, ridges or whirls. The protrusions 32, 42, need not necessarily be continuous; some portions of the interface 22 could be parallel with the line of the join 24. Changed forms for the protrusions 32, 42 may affect the interface 22, changing it from a zigzag to another shape. Nevertheless it is desirable to maintain a somewhat convoluted interface 22 to realise the benefits of at least a portion of tension across the join 24 being experienced as shear at the interface 22.

Although illustrated a symmetric ridges in FIG. 3 the protrusions 32 on the first member 30 may be different to the protrusions 42 on the second member 40 but still complementary in form. For example, protrusions 32 on the first member 30 could be pyramidal, and the protrusions 42 on the second member could be a series of perpendicular ridges defining pyramidal gaps for interlocking with pyramidal protrusions 32.

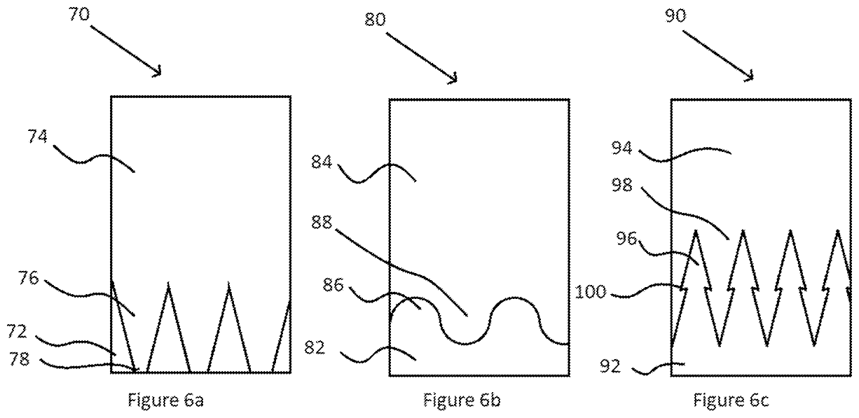

With reference to FIGS. 6a to 6c some alternative forms for the protrusions are now described. In one embodiment as shown in FIG. 6a, a multi-material component 70 is shown that seeks to further reduce the size of the first member 72. The first member 72 and second member 74 are joined by complementary protrusions as before. However the first member 72 in this case contains a number of holes 78 that receive the protrusions 76 of the second member 74. In this embodiment the lattice 60 may be designed to avoid contacting the protrusions 76 of the second member 74, instead only making contact with those parts of the first member 72 adjacent to the lattice 60. Further alternatively, the first member 72 could be reduced to a series of smaller members that fit between the protrusions 76 of the second member 74.

With reference to FIG. 6b, an alternate protrusion design is shown which may be more suitable for use where the additive manufacturing method does not support high aspect-ratio features. The multi-material component 80 again comprises a first member 82 and second member 84, but in this case each has complementary protrusions 86, 88 which are rounded in profile and do not have a high aspect ratio. The resulting curved interface 22 still has significant portions which are at an angle to the join 24.

With reference to FIG. 6c, a further alternate protrusion design is shown which may increase the strength of the multi-material join. Again, the multi-material component 90 has a first member 92 and a second member 94, each having complementary protrusions 96, 98 which feature an interlocking barb 100. Each protrusion 96, 98 may feature one or more barbs which may increase the resilience of the multi-material component 90 to stress.

Although the invention has been described above with reference to one or more preferred examples or embodiments, it will be appreciated that various changes or modifications may be made without departing from the scope of the invention as defined in the appended claims.

Although the invention has been described above mainly in the context of a metallic multi-material component for use in an engine pylon in a fixed-wing aircraft application, it may also be advantageously applied to various other applications, including but not limited to applications on vehicles such as helicopters, drones, trains, automobiles and spacecraft, and those made of other combinations of materials such as plastics and ceramics.

Where the term “or” has been used in the preceding description, this term should be understood to mean “and/or”, except where explicitly stated otherwise.

1. A multi material component comprising:
a first member formed of a first material and a second member formed of a second material, the first and second members each comprising complementary protrusions that form a multi-material join and define an interface between the first and second members such that a substantial proportion of any tension between the first and second members across the multi-material join is experienced as a shear force at the interface;
a third member; and
a lattice member situated and joined between the first member and the third member, the lattice being capable of elastic deformation so as to substantially isolate the multi-material join from any deformation of the third member.

2. A multi-material component according to claim 1, wherein the third member and lattice member are formed of the first material.

3. A multi-material component according to claim 1, wherein the lattice has an elastic limit below the breaking stress of the multi-material join so as to allow non-destructive inspection of the component by inspecting the lattice for plastic deformation.

4. A multi-material component according to claim 1, wherein the first material and second material have substantially different coefficients of thermal expansion.

5. A multi-material component according to claim 1, wherein the first material and second materials are metals that form brittle inter-metallic compounds when welded together.

6. A multi-material component according to claim 1, wherein at least one of the first member and second member have been formed by additive manufacture upon the other member such that the interface between the complementary protrusions has been formed by additive manufacture.

7. A multi-material component according to claim 1, wherein the first member comprises holes for receiving the protrusions of the second member.

8. A multi-material component according to claim 1, wherein the complementary protrusions are elongated so as to form a series of complementary ridges.

9. A multi-material component according to claim 1, wherein the complementary protrusions are barbed.

10. A multi-material component according to claim 1, wherein the complementary protrusions are spaced across the multi-material join such that no significant part of the interface is parallel to the plane of the multi-material join.

11. A multi-material component according to claim 1, wherein the first material is Inconel and the second material is Aluminium.

12. A method of designing a multi-material component for use in coupling a heat source to a vehicle, the multi-material component comprising a first member formed of a first material and a second member formed of a second material, the first and second members each comprising complementary protrusions that form a multi-material join and define a interface between the first and second members; and a lattice member situated and joined between the first member and a third member; the method comprising:
selecting the first material and second material;
identifying an operating temperature for the third member;
identifying a maximum acceptable temperature of the second material;
determining a range of acceptable values for thermal conductivity of the lattice which will, at the operating temperature of the third member, prevent the temperature of the second member exceeding the maximum acceptable temperature; and
using software to generate the design of the lattice with a thermal conductivity within the range of acceptable values.

13. A method according to claim 12, wherein the second material is Aluminium and the maximum acceptable temperature is 300 degrees Celsius.

14. A pylon for connecting a heat source to an aircraft structure, the pylon comprising the multi-material component of claim 1, wherein:
the third member is coupled to the heat source; and
the second member is coupled to the aircraft structure.

15. A method of creating a multi-material component, the component comprising a multi-material join where two different materials are joined together, the method comprising:
a first step of providing a second member formed of a second material, the second member comprising a plurality of protrusions;
a second step of constructing via additive manufacturing a first member formed of the first material on the second member by first constructing a plurality of protrusions complementary to those of the second member so as to create an interface between the complementary protrusions of the second and first member;
a third step of constructing via additive manufacturing a lattice formed of the first material on the first member;
a fourth step of constructing via additive manufacturing the third member formed of the first material on the lattice; wherein
the lattice is configured to elastically deform so as to substantially isolate the interface between the complementary protrusions from distortions in a third member connected to the lattice.

16. A method of creating a multi-material component according to claim 15, wherein the step of providing the second member comprises constructing the second member via additive manufacturing.

17. A method of creating a multi-material component according to claim 16, wherein the complementary protrusions on the second and first member are constructed at the same time via multi-material additive manufacturing.

18. A method of creating a multi-material component, the component comprising a multi-material join where two different material are joined together, the method comprising:
a first step of providing a third member formed of a first material;
a second step of constructing via additive manufacturing a lattice formed of the first material on the first member, the lattice being configured to elastically deform so as to substantially isolate the side of the lattice distal from the third member from distortions in the third member;
a third step of constructing via additive manufacturing a first member formed of the first material on the lattice, the first member comprising a plurality of protrusions; and
a fourth step of constructing via additive manufacturing a second member formed of a second material, the second member comprising a plurality of protrusions complementary to those of the first member so as to create an interface between the complementary protrusions of the first and second member.
